(19) United States
(12) Patent Application Publication
(10) Pub. No.: US 2026/0134416 A1
(43) Pub. Date: May 14, 2026

(54) DYNAMIC MODIFICATION OF AN INITIAL DIGITAL TIP BY DELAYING PROCESSING OF A DIGITAL TRANSACTION AT A POINT OF TRANSACTION SYSTEM

(71) Applicant: Chime Financial, Inc., San Francisco, CA (US)

(72) Inventor: Igor dos Santos Ramos, Round Rock, TX (US)

(21) Appl. No.: 18/946,478

(22) Filed: Nov. 13, 2024

(51) Int. Cl. G06Q 20/32; G06Q 20/08; G06Q 20/20; G06Q 20/40

(52) U.S. Cl. CPC G06Q 20/326; G06Q 20/202; G06Q 20/40; G06Q 20/0855

(57) ABSTRACT

The present disclosure relates to systems, non-transitory computer-readable media, and methods for generating a final digital tip by causing a point of transaction system to delay processing an initial digital tip. For example, in one or more embodiments, the disclosed system receives a digital transaction that includes a digital transaction amount and an initial digital tip. In one or more embodiments, the disclosed system causes the point of transaction system to delay processing the initial digital tip for a predetermined period of time. Moreover, in some embodiments, the disclosed system provides an option for a client device to modify the initial digital tip. In response to a selection of the option to modify the initial digital tip and in response to the expiration of the predetermined period of time, the disclosed system generates the final digital tip amount for the point of transaction system to process.

### BACKGROUND

Recent years have seen significant improvements in utilizing computing devices to facilitate transactions and events associated with digital financial transactions. One event associated with digital transactions is providing a digital tip in addition to the cost of a transaction, where the digital tip can indicate an amount of satisfaction with the rendered service and/or good. For example, most merchants provide an option for consumers to provide a digital tip at the same time as paying (e.g., via a card using a card payment terminal device). Furthermore, most merchants typically suggest an amount of digital tip to provide at the card payment terminal device (e.g., as part of the purchase of goods or services). Despite the advances in capability of providing digital tips, existing systems suffer from a number of issues related to efficiency, accuracy, and operational flexibility.

As mentioned above, most merchants provide an option to provide a digital tip at the time of purchasing goods or services. Because of this, many consumers encounter social pressure to leave disproportionately high tips (even for minor purchases). Specifically, the pervasiveness of requesting digital tips in most goods and services settings causes both consumers and service workers (e.g., employees of a merchant) to become uncomfortable, due to the possibility of a low digital tip being provided or no digital tip being provided.

In some instances, due to the pervasive nature of requesting digital tips and the social pressure hoisted upon consumers to give digital tips, existing financial transaction systems suffer from a variety of inefficiencies. For example, existing financial transaction systems typically receive an onslaught of dispute requests from consumers after a digital transaction (e.g., that includes a digital tip) has been settled. Specifically, because consumers are being pressured with providing a tip (e.g., even for minor purchases, such as a $3 coffee), this results in consumers providing a disproportionately high digital tip or providing a digital tip that they did not want to provide in the first place. As such, consumers dispute the transaction after it has been settled. In doing so, existing financial transaction systems waste computational resources and time to resolve consumer disputes (e.g., that often result from consumers providing the tip because of the social pressure).

For instance, existing financial transaction systems have to invest in computational resources to investigate and either refuse the dispute, refund the dispute, request a chargeback from the merchant, or find a way to provide merchant credits to a consumer. In doing so, computing devices and computing systems associated with existing financial transaction systems are bogged down with dispute requests. As highlighted above, the utilization of computing resources to resolve these disputes are a result of the culture and nature of digital tipping that is pervasive in most goods and services industries. Thus, existing financial transaction systems suffer from a variety of inefficiencies due to the pervasiveness of requesting digital tips in goods and services settings.

Relatedly, the pervasive nature of requesting digital tips also distorts the accuracy of digital tips that are provided to service workers/merchants. For example, because consumers feel pressure to provide digital tips (e.g., or they may face an uncomfortable situation and the service worker may react negatively), consumers inaccurately provide tips that may not be commensurate with or in scope with the context of the digital transaction (e.g., disproportionate). Because of how existing financial transaction systems have established their tipping systems, this incentivizes disputes because a consumer merely feels like they were pressured into giving an inaccurate digital tip at a disproportionate amount.

On the other side of the coin, some consumers may become hardened and refuse to provide any digital tips, even for contexts where a digital tip make sense. For example, because consumers feel that merchants pervasively request digital tips, some consumers may refuse to provide any digital tips, even in settings where service workers rely heavily on consumer digital tips. In such instances, consumers may regret not providing any tip (or very low tips) after the digital transaction has already occurred.

Existing financial transaction systems not only cause consumer regret for providing disproportionately high digital tips, but existing financial transaction systems also cause some consumers to provide disproportionately low or no digital tips at all, even for settings where a digital tip makes sense. Thus, existing financial transaction systems incentivize inaccurate digital tipping practices in both directions (e.g., disproportionately high and disproportionately low). Accordingly, the inaccuracies of existing financial transaction systems further exacerbate the inefficiencies in existing financial transaction systems (e.g., by causing an uptick in dispute requests and other post-settlement computer processes).

Moreover, existing financial transaction systems further suffer from operational inflexibilities. For example, existing financial transaction systems fail to provide alternatives for consumers who are bombarded with digital tip requests and see no alternative but to dispute the provided digital tips. As such, existing financial transaction systems rigidly use the same methods to try and resolve unsatisfied consumers, but in doing so increase the use of computing resources and time. Thus, existing financial transaction systems are operationally inflexible.

### BRIEF SUMMARY

This disclosure describes one or more embodiments of methods, non-transitory computer-readable media, and systems that can solve the foregoing problems in addition to providing other benefits by causing a point of transaction system to delay processing an initial digital tip amount and providing an option to a client device of a user account modify the initial digital tip amount. For example, the disclosed systems receive a digital transaction corresponding to a user account of a client device from a point of transaction system and the digital transaction includes a digital transaction amount and an initial digital tip amount. Furthermore, in response to receiving the digital transaction, the disclosed systems cause the point of transaction system to delay processing the initial digital tip amount for a predetermined period of time. Moreover, in some embodiments, the disclosed systems provide for display on a graphical user interface of a client device (and prior to expiration of a predetermined period of time) an option to modify the initial digital tip amount. In some embodiments, based on a selection of the option to modify the initial digital tip amount and in response to an expiration of the predetermined period of time, the disclosed systems generate a final digital tip amount for the point of transaction system to process.

Additional features and advantages of one or more embodiments of the present disclosure are outlined in the description which follows, and in part will be obvious from the description, or may be learned by the practice of such example embodiments

### BRIEF DESCRIPTION OF THE DRAWINGS

The detailed description provides one or more embodiments with additional specificity and detail through the use of the accompanying drawings, as briefly described below.

FIG. 1 illustrates an overview diagram of a dynamic digital tip system causing a point of transaction system to delay processing an initial digital tip in accordance with one or more embodiments.

FIG. 2 illustrates an example diagram of the dynamic digital tip system authorizing a digital transaction and settling a digital transaction in accordance with one or more embodiments.

FIG. 3 illustrates an example diagram of the dynamic digital tip system extracting contextual merchant metadata to assist a client device in modifying an initial digital tip in accordance with one or more embodiments.

FIG. 4 illustrates an example diagram of the dynamic digital tip system determining contextual tip metadata to assist a client device in modifying an initial digital tip in accordance with one or more embodiments.

FIG. 5 illustrates an example graphical user interface of the dynamic digital tip system providing an option to modify an initial digital tip in accordance with one or more embodiments.

FIG. 6A illustrate an example diagram of the dynamic digital tip system performing a variety of actions to provide operational flexibility in adjusting a digital tip in accordance with one or more embodiments.

FIG. 6B illustrate an example diagram of the dynamic digital tip system directly integrating with a point of transaction system to modify a digital tip in accordance with one or more embodiments.

FIG. 7 illustrates a block diagram of an environment for implementing a dynamic digital tip system in accordance with one or more embodiments.

FIG. 8 illustrates an example series of acts for generating a final digital tip in accordance with one or more embodiments.

FIG. 9 illustrates a block diagram of a computing device for implementing one or more embodiments of the present disclosure.

FIG. 10 illustrates an example environment for the dynamic digital tip system in accordance with one or more embodiments.

### DETAILED DESCRIPTION

This disclosure describes one or more embodiments of a dynamic digital tip system 100 that receives a digital transaction with an initial digital tip amount and causes a point of transaction system to delay processing the initial digital tip amount for a predetermined period of time (e.g., to allow modifications/adjustments to the initial digital tip amount). In other words, the dynamic digital tip system 100 shifts the digital tipping process from an immediate, real-time action to a delayed process that allows assisting and informing a client device (e.g., with artificial intelligence generated insights and contextual data) on how to modify an initial digital tip amount. For example, the dynamic digital tip system 100 turns the paradigm of traditional digital tipping on its head by providing users of client devices significant leverage and agency in their digital tipping decisions. Specifically, the dynamic digital tip system 100 causes a delay of processing the initial digital tip amount, provides an option on a graphical user interface of a client device to modify the initial digital tip amount, and based on a selection of the option to modify the initial digital tip amount (and in response to an expiration of a predetermined period of time), the dynamic digital tip system 100 generates a final digital tip amount for the point of transaction system to process.

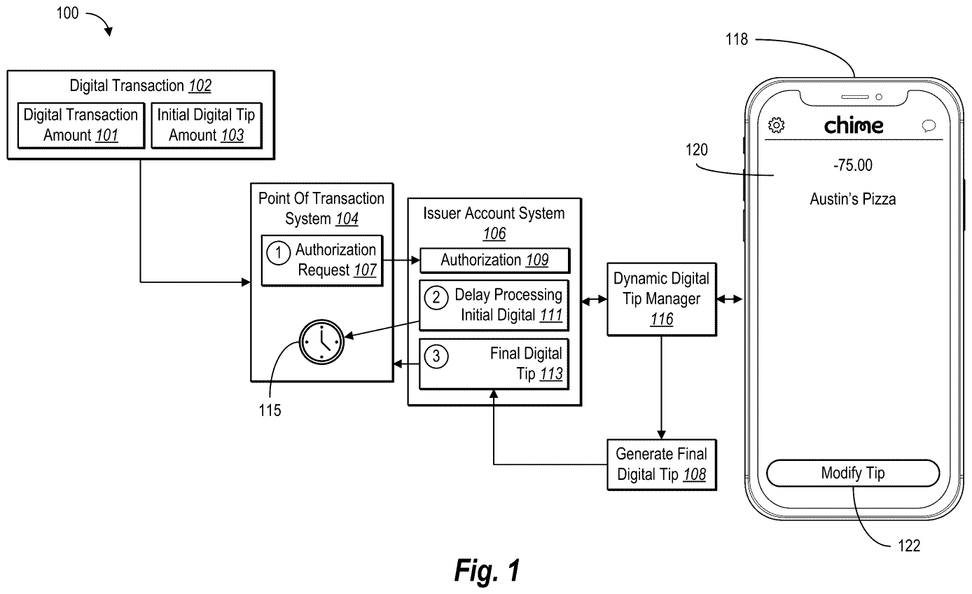

As shown in FIG. 1, the dynamic digital tip system 100 receives a digital transaction 102 that includes a digital transaction amount 101 and an initial digital tip amount 103. In one or more embodiments, the digital transaction 102 refers to a transaction in exchange of goods, services, or information that occurs electronically. Specifically, the digital transaction 102 occurs by a system transmitting a network signal via a network to a transaction processing system which further communicates with additional systems. For example, the digital transaction 102 initially occurs via a first system (e.g., a point of transaction system 104) which then transmits a data payload to a second system (e.g., an issuer account system 106) via a network (e.g., specifically a transaction processing system) for authorization. In response to authorization, the point of transaction system is allowed to proceed with the digital transaction 102.

As mentioned above, FIG. 1 shows that the digital transaction 102 includes the digital transaction amount 101 and the initial digital tip amount 103. In one or more embodiments, the digital transaction amount 101 refers to a specific digital monetary value being transferred from a payer (e.g., a client device) to a payee (a merchant of the point of transaction system) as part of a digital transaction. Specifically, the digital transaction amount 101 refers to a total cost of goods, services, or information being purchased, and can include additional charges like taxes, fees, or discounts.

Further, in one or more embodiments, the digital transaction 102 further includes the initial digital tip amount 103. Specifically, the initial digital tip amount 103 refers to an amount of digital monetary value voluntarily contributed by a client device (payer) to one or more service workers for a merchant of the point of transaction system 104. For example, the initial digital tip includes an amount in addition to the digital transaction amount 101 of the good, service, or information. For instance, the initial digital tip amount 103 can signal a level of appreciation from a user of a client device to one or more service workers for a merchant of the point of transaction system 104.

In one or more embodiments, the point of transaction system 104 can request a user of a client device to provide a tip (e.g., as the point of transaction system 104 is programmed to requests digital tips) despite there being no formal service workers present or traditional service being provided by a service worker (e.g., fast food tips). Moreover, the initial digital tip amount 103 is typically discretionary and voluntary according to the user of the client device, however, certain regions/merchants automatically add an initial digital tip to a digital transaction (e.g., for large parties or specific services).

In one or more embodiments, the point of transaction system 104 provides one or more suggestions for an initial digital tip to add to the digital transaction. For example, upon swiping a physical card or using a mobile application to make a payment, a point of transaction terminal device displays suggested tip amounts for a user of the client device to add to the digital transaction 102.

As shown in FIG. 1, the dynamic digital tip system 100 receives the digital transaction 102 and utilizes the point of transaction system 104 to initiate sending an authorization request 107 to the issuer account system 106. In one or more embodiments, the point of transaction system 104 refers to a system where a digital transaction occurs between a client device and a merchant. Specifically, the point of transaction system 104 includes a system that is tied to virtual and/or physical locations that sell merchandise and/or services and process digital transactions for purchasing merchandise and/or services.

For example, the point of transaction system 104 is tied to one or more merchants and can include a point of transaction terminal (e.g., point of transaction device) to process digital transactions from a physical card or a client device. Moreover, the point of transaction system 104 includes a software that manages the digital transactions that are transmitted to the point of transaction terminal (e.g., a payment receiver). For instance, software of the point of transaction system 104 includes streamlining order processing, payment collection, and other types of digital transactions. To illustrate, when a client device purchases goods/services, the software of the point of transaction system processes a payment method (e.g., credit, debit, digital pay via a mobile device) and transmits the digital transaction associated with the payment method to the issuer account system 106 (e.g., transmits the authorization request 107 to an issuing bank).

In other words, multiple merchants can interface with/integrate with the point of transaction system 104 to process digital transactions. In some embodiments, the merchant has an internal software program that acts as the point of transaction system itself and does not utilize an additional system layer to process the digital transactions. In some embodiments, the point of transaction system 104 offers a client device an option to provide a digital tip in addition to the merchandise/services provided to the client device. Moreover, in some embodiments, after the digital transaction has been transmitted to the point of transaction terminal, the point of transaction system 104 causes the point of transaction terminal to generate a receipt (e.g., physical or digital) to provide to the client device.

As shown in FIG. 1, the dynamic digital tip system 100 uses the point of transaction system 104 to send the authorization request 107 to the issuer account system 106, and further utilizes the issuer account system 106 to process the authorization request 107. In one or more embodiments, the issuer account system 106 refers to an issuer of digital credit via a credit card and/or a debit card to a client device. Specifically, the issuer account system 106 manages a client device of a user account's credit limits and payment obligations (e.g., based on digital transactions of the client device of the user account). Specifically, the issuer account system 106 grants a client device of a user account a line of credit, establishes credit limits, and manages repayments for borrowed credit. In some instances, such as for debit cards, the issuer account system links a user account to a bank account (e.g., the balance of the bank account acts as a credit limit).

As shown in FIG. 1, the dynamic digital tip system 100 utilizes the issuer account system 106 to determine that a client device of a user account associated with the digital transaction 102 has sufficient credit and approves the authorization request 107 (e.g., provides authorization 109). FIG. 1 further shows the dynamic digital tip system 100 performing an act 111 to transmit a data signal to the point of transaction system 104 to delay processing the initial digital tip amount 103 for a predetermined period of time 115. In one or more embodiments, the dynamic digital tip system 100 transmits a communication to the point of transaction system 104 to delay processing includes indicating to the point of transaction system 104 to wait (for a period of time) before sending a request to the issuer account system 106 (and subsequently the merchant account system) to finalize the digital transaction (e.g., that includes the initial digital tip). In other words, the dynamic digital tip system 100 indicates to the point of transaction system 104 to not process an initial digital tip part of a digital transaction until a predetermined period of time has passed.

In one or more embodiments, the dynamic digital tip system 100 instructs the point of transaction system 104 to delay processing an initial digital tip for the predetermined period of time 115. For example, the predetermined period of time 115 refers to a pre-established or a preset number of hours or days before an initial digital tip is processed by the point of transaction system 104 (e.g., and eventually finalized). In some embodiments, the dynamic digital tip system 100 utilizes the issuer account system 106 to indicate to the point of transaction system 104 the predetermined period of time. In some embodiments, the dynamic digital tip system 100 utilizes the point of transaction system 104 to determine the predetermined period of time 115.

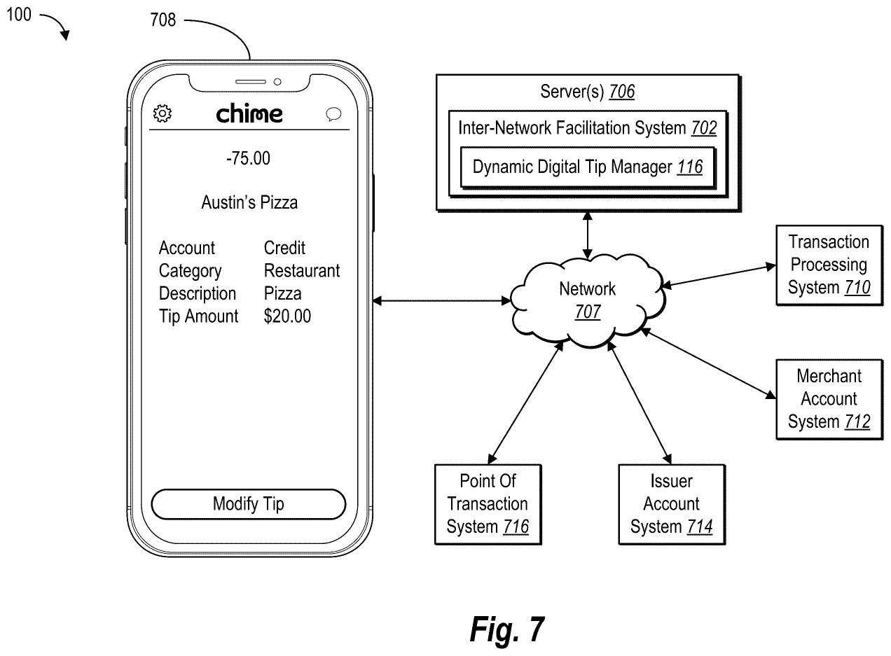

As shown in FIG. 1, the dynamic digital tip system 100 further utilizes a dynamic digital tip manager 116 to interact with the issuer account system 106 and a client device 118. In one or more embodiments, the client device 118 refers to a computing device that accesses services and functions of the dynamic digital tip system 100, and more broadly the services and functions of an internetwork facilitation system (e.g., discussed below in FIG. 7). For example, the client device 118 accesses (e.g., via the user account) account information such as a remaining debit balance, credit remaining on the user account, and specific suggestions provided by the dynamic digital tip system 100. Specifically, in some embodiments, the client device 118 initiates the dynamic digital tip system 100 receiving the digital transaction 102 by swiping a credit or debit card at the point of transaction system 104 (e.g., a merchant) or by utilizing an application of the client device to directly transmit the digital transaction to the point of transaction system.

As mentioned above, the client device accesses the dynamic digital tip system 100 by having access to a user account of the dynamic digital tip system 100. In one or more embodiments, a user account refers to a digital profile part of the dynamic digital tip system 100 (e.g., and also part of a internetwork facilitation system discussed below in FIG. 7) that allows a client device linked to the user account to access services, data or functionalities native to the dynamic digital tip system 100. Specifically, the dynamic digital tip system 100 allows a client device to authenticate their identity to gain access to the user account. For example, a user account has default and set preferences for performing digital transactions (e.g., credit transactions, debit transactions, digital tips, notifications for spending and saving actions, etc.). Moreover, the user account further includes digital activity history, security settings, and permissions/privileges for one or more client devices linked to the user account.

As mentioned above, the dynamic digital tip system 100 utilizes the dynamic digital tip manager 116 to interact with the issuer account system 106 and the client device 118. In some embodiments, the dynamic digital tip manager 116 acts as a software layer on top of the issuer account system 106. In other words, the dynamic digital tip system 100 utilizes the dynamic digital tip manager 116 to act as a data layer between the issuer account system 106 and the client device 18 of a user account to allow the client device 118 of a user account to modify/adjust an initial digital tip amount. For instance, the dynamic digital tip manager 116 integrates with the issuer account system 106 to obtain data (e.g., authorization requests, digital transaction amount, initial digital tip amount, contextual merchant metadata, and contextual tip metadata) and provide the obtained data to the client device 118. Furthermore, in response to a modification to an initial digital tip amount, the dynamic digital tip system 100 utilizes the dynamic digital tip manager 116 to transmit the modified amount to the issuer account system 106, and the issuer account system 106 in turn transmits the modified digital tip (e.g., a final digital tip) to the point of transaction system 104.

As shown in FIG. 1, the dynamic digital tip system 100 provides on a graphical user interface 120 of the client device 118 an option 122 to modify a digital tip. In one or more embodiments, the dynamic digital tip system 100 provides a selectable graphical user interface element for a user of a client device to select. In response to a selection of the option 122 to modify the tip, the dynamic digital tip system 100 causes the graphical user interface to display an option to input/submit a specific amount as the digital tip (e.g., modify the initial digital tip with a new tip amount).

In response to the dynamic digital tip system 100 receiving a selection of the option 122 and further receiving a modification to the initial digital tip amount 103, the dynamic digital tip system 100 utilizes the dynamic digital tip manager 116 to generate a final digital tip 108. In one or more embodiments, the dynamic digital tip system 100 modifies the initial digital tip amount 103 and generates the final digital tip 108. Specifically, the final digital tip 108 amount includes an amount of digital tip to be processed by the point of transaction system 104 for future settlement of funds that include the digital transaction 102 with the final digital tip 108 amount (e.g., an act 113 of the dynamic digital tip system 100 sending the final digital tip 108 to the point of transaction system 104). For example, the dynamic digital tip system 100 can receive a single modification to the initial digital tip amount 103 (e.g., $5 initial digital tip to $6 digital tip), or the dynamic digital tip system 100 can receive multiple modifications to the initial digital tip amount 103 (e.g., within the predetermined period of time, $5 initial digital tip to $6 digital tip, to $10 digital tip).

As suggested above, the dynamic digital tip system 100 provides several improvements or advantages over conventional systems. For example, the dynamic digital tip system 100 can improve on the efficiency of existing financial transaction systems. As mentioned above, existing financial transaction systems suffer from a variety of inefficiencies due to the pervasiveness of merchants requesting digital tips in most goods and services settings, which results in disproportionate tips and an onslaught of dispute requests from consumers to undo the disproportionate tips. In contrast to existing financial transaction systems, the dynamic digital tip system 100 causes the point of transaction system 104 to delay processing the initial digital tip amount 103 of the digital transaction 102 for a predetermined period of time. In doing so, the dynamic digital tip system 100 allows a client device a predetermined period of time to determine whether or not they want to adjust the initial digital tip amount 103.

In other words, the dynamic digital tip system 100 dispels the social pressure associated with merchants requesting digital tips, by causing a delay in the processing of digital tips for a predetermined period of time. Thus, the client device has a sufficient amount of time to determine whether the initially provided digital tip was too high or too low. Moreover, because of the technical ability of the dynamic digital tip system 100 to cause the point of transaction system 104 to delay processing the initial digital tip, the dynamic digital tip system 100 further reduces the number of dispute requests from consumers after a digital transaction. Thus, dynamic digital tip system 100 reduces the number of computational resources and time allocated towards resolving disputes, and also reduces the number of computational resources employed to perform chargebacks, merchant credits, or other system-level actions to resolve disputes for dissatisfied consumers. Accordingly, the dynamic digital tip system 100 improves the computational efficiency of financial transaction systems (e.g., relative to existing systems) by freeing up computer resources.

Moreover, the dynamic digital tip system 100 improves upon the accuracy of existing financial transaction systems. As mentioned above, existing financial transaction systems distort the accuracy of digital tips because consumers feel immense pressure to provide digital tips that are not commensurate in scope with the context of the digital transaction. Further, existing financial transaction systems further incentivize disputes because of the digital tips not being commensurate in scope with the context of the digital transaction. In contrast, the dynamic digital tip system 100 receives the digital transaction 102 that includes the initial digital tip amount 103 and causes the point of transaction system 104 to delay processing the initial digital tip amount 103 for a predetermined period of time. Specifically, the dynamic digital tip system 100 provides an option to the client device (prior to expiration of the predetermined period of time) to modify the initial digital tip amount.

In doing so, the dynamic digital tip system 100 allows a client device to make informed pressure-free decisions regarding their digital tipping practices. For instances, where the client device felt that the initial digital tip amount 103 was too high, the client device can submit a modified digital tip amount that reduces the initial digital tip amount 103. On the other hand, some client devices may realize that they provided too low of a digital tip or neglected to provide any digital tips, and these client devices can submit changes to increase the initial digital tip amount 103 or add a digital tip that was not included in the first place. Because of this, the dynamic digital tip system 100 enables the point of transaction system 104 to process accurate digital tips and not deal with a high volume of dispute requests.

Furthermore, in some embodiments, the dynamic digital tip system 100 provides to a client device a suggested tip amount based on contextual merchant metadata and contextual tip metadata for a user account. In other words, the dynamic digital tip system 100 intelligently informs a client device regarding various tipping practices of a specific merchant (e.g., pooled tipping versus direct tipping) and further predicts an amount that the client device would likely want to provide as a digital tip. For example, the dynamic digital tip system 100 draws from contextual tipping data to assist a client device to make informed digital tipping decisions, which further improves the accuracy of digital tipping.

As mentioned, the dynamic digital tip system 100 draws from contextual tip metadata for a user account. Specifically, the dynamic digital tip system 100 employs a specially trained machine learning model to process user account data (e.g., historical activity, user preferences, etc.). For example, the dynamic digital tip system 100 utilizes the specially trained and tailored machine learning model to generate digital tipping predictions to assist a client device. Because of the specially trained and tailored machine learning model, the dynamic digital tip system 100 further improves the accuracy of digital tipping practices and reduces the waste of computing resources used for resolving dispute requests.

Relatedly, the dynamic digital tip system 100 improves upon operational flexibility relative to existing financial transaction systems. As mentioned above, existing financial transaction systems fail to provide alternatives for consumers who are bombarded with digital tip requests, which results in a high volume of dispute requests and post-settlement actions (e.g., which consumes a high volume of computational resources). In contrast to existing financial transaction systems, the dynamic digital tip system 100 causes the point of transaction system 104 to delay processing the initial digital tip amount 103 and provides an option for a client device to modify the initial digital tip amount within a predetermined window of time. Specifically, the dynamic digital tip system 100 reduces the immense social pressure associated with digital tipping and allows for client devices to make more informed, reflective, and deliberate decisions with digital tipping. Thus, the dynamic digital tip system 100 provides more operational flexibility to financial transaction systems and rectifies issues associated with disproportionate digital tips.

Indeed, the dynamic digital tip system 100 provides a technical solution to a problem that arose within digital payment and transaction systems. Indeed, by using novel technical methods and systems for delaying the processing of a digital tip, providing digital options for modification of a digital tip, and then processing the digital tip after confirmation or after a predetermined time period, the dynamic digital tip system 100 overcomes problems inherent in prior digital payment and transaction systems.

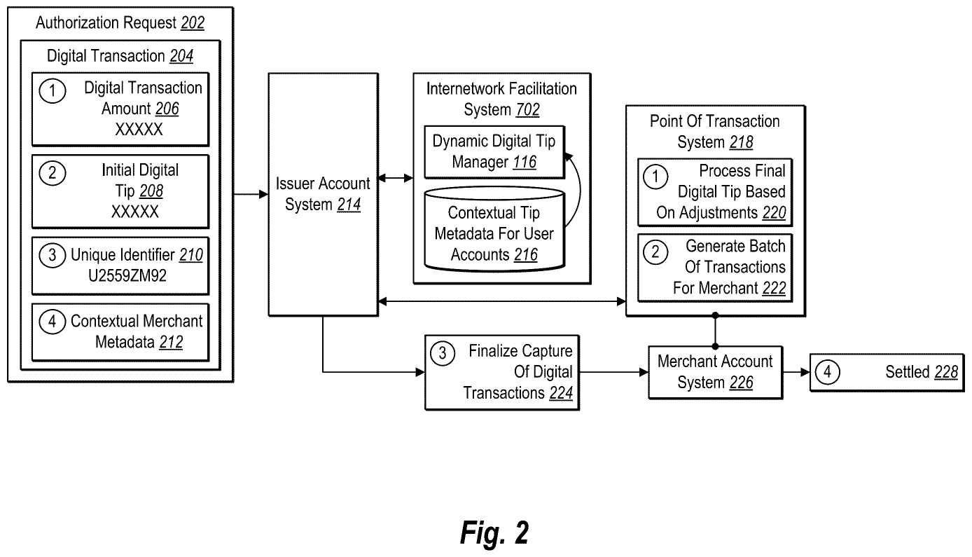

As discussed above, the dynamic digital tip system 100 extracts relevant data for a digital transaction to provide intelligent data to a client device. For example, FIG. 2 illustrates an example diagram of the dynamic digital tip system 100 processing an authorization request, extracting contextual merchant metadata and contextual tip metadata for a user account and eventually settling a digital transaction in accordance with one or more embodiments.

As shown in FIG. 2, the dynamic digital tip system 100 receives an authorization request 202. In one or more embodiments, the dynamic digital tip system 100 utilizes a point of transaction system 218 to transmit the authorization request 202 to an issuer account system 214 as part of a payment process by a client device. Specifically, the dynamic digital tip system 100 utilizes the point of transaction system 218 to send the authorization request 202 to receive approval from the issuer account system 214 to proceed with a digital transaction 204. In other words, the dynamic digital tip system 100 utilizes the point of transaction system 218 to confirm (e.g., with the authorization request 202) that the client device of the user account has sufficient funds or credit to complete the digital transaction 204 (e.g., the point of transaction system 218 ensures the validity of the digital transaction 204). To illustrate, the authorization request 202 includes a digital transaction amount 206, an initial digital tip 208, a unique identifier 210 for the digital transaction 204, and contextual merchant metadata 212.

In one or more embodiments, the dynamic digital tip system 100 generates the unique identifier 210 for the digital transaction 204. Specifically, the unique identifier 210 includes a distinct, one-of-a-kind code assigned to the digital transaction 204 to uniquely distinguish the digital transaction 204 from all other digital transactions. For instance, the issuer account system 214 assigns a unique identifier to each digital transaction to communicate with the point of transaction system 218 in delaying a specific digital transaction (e.g., by referencing the unique identifier).

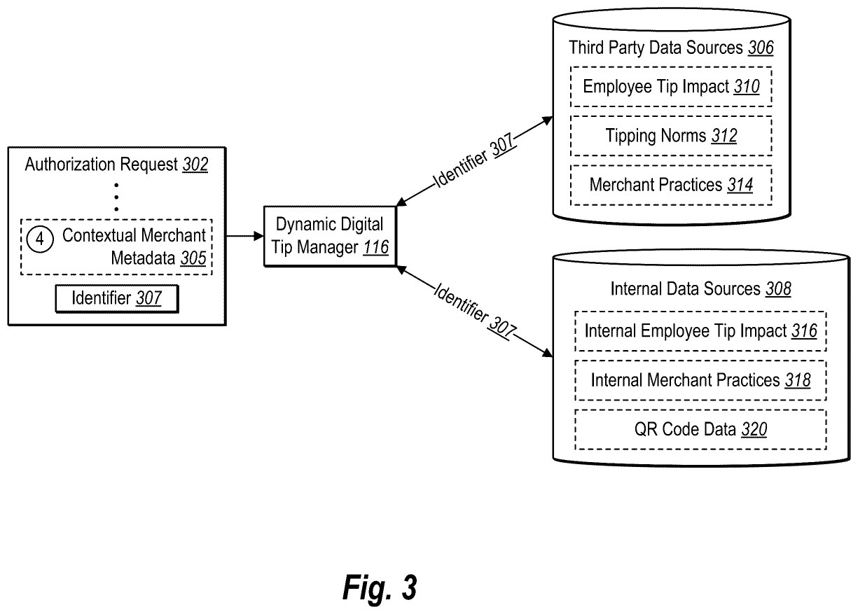

In one or more embodiments, the dynamic digital tip system 100 obtains the contextual merchant metadata 212 from the authorization request 202. For example, the contextual merchant metadata 212 refers to information that provides context for digital tipping practices of a specific merchant (e.g., vendor) that can assist a client device of a user account in determining how much of a digital tip to provide. Specifically, the dynamic digital tip system 100 can obtain the contextual merchant metadata 212 from the authorization request 202 sent to the issuer account system 214 and/or the dynamic digital tip system 100 obtains contextual merchant metadata from data sources that store the merchant data. Additional details of this are provided below in FIG. 3.

As shown in FIG. 2, the dynamic digital tip system 100 establishes a dynamic communication between the issuer account system 214 and the point of transaction system 218 (e.g., as indicated by the double arrow between the issuer account system 214 and the point of transaction system 218). For example, a dynamic communication refers to a communication channel between systems. Specifically, the dynamic digital tip system 100 establishes the communication channel for a predetermined period of time in order for a system (e.g., the issuer account system 214) to transmit a modification to a digital tip amount to another system (e.g., the point of transaction system 218). For instance, the dynamic communication includes the dynamic digital tip system 100 utilizing the issuer account system 214 to send a payload (e.g., a data packet) to the point of transaction system 218 to delay processing the initial digital tip 208 for a predetermined period of time. Specifically, the dynamic communication channel between the point of transaction system 218 and the issuer account system 214 allows for one or multiple modifications to the initial digital tip amount.

As shown in FIG. 2, the dynamic digital tip system 100 further establishes a communication between an inter-network facilitation system 702 (discussed in detail below in FIG. 7) and the issuer account system 214. For instance, the dynamic digital tip system 100 utilizes the communication between the inter-network facilitation system 702 and the issuer account system 214 to determine a relevant merchant (e.g., the point of transaction system 218) for the digital transaction 204 and a relevant user account for the client device. In particular, the dynamic digital tip system 100 utilizes the dynamic digital tip manager 116 to detect the relevant type of merchant and the user account of the digital transaction 204.

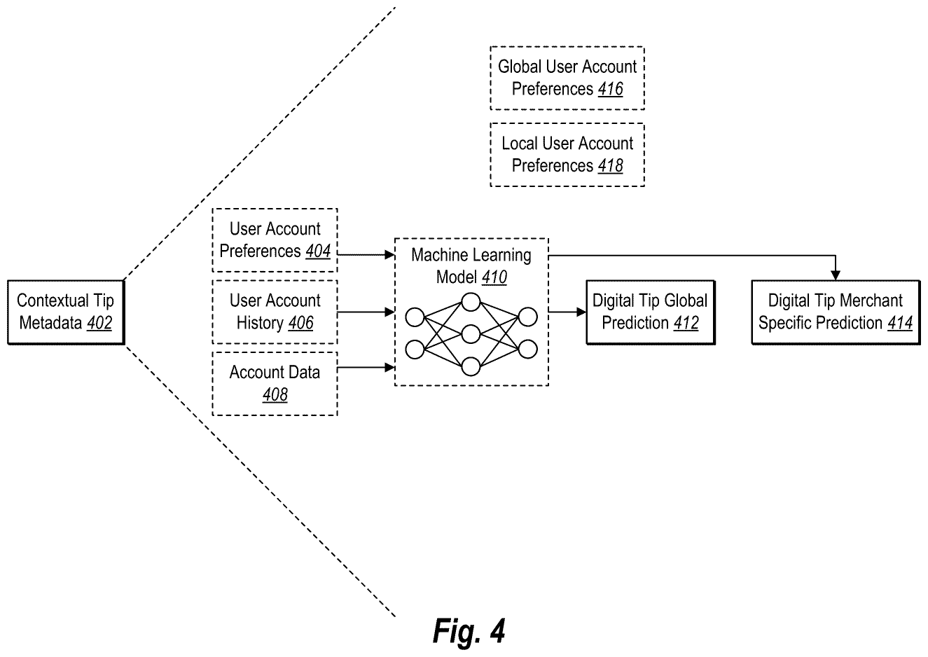

As shown in FIG. 2, the dynamic digital tip system 100 utilizes the dynamic digital tip manager 116 to extract contextual tip metadata 216 for user accounts. Specifically, the dynamic digital tip system 100 determines a specific user account for the digital transaction 204 and extracts the relevant data. In one or more embodiments, the dynamic digital tip system 100 obtains the contextual tip metadata 216. For example, the contextual tip metadata 216 refers to user preferences of the user account for providing digital tips. Specifically, the dynamic digital tip system 100 identifies user account preferences (e.g., global user account preferences and local user account preferences), and further utilizes artificial intelligence to provide informed predictions for digital tipping. Additional details of the contextual tip metadata 216 is given below in the description of FIG. 4.

As shown in FIG. 2, the dynamic digital tip system 100 utilizes the point of transaction system 218 to perform an act 220 of processing a final digital tip based on adjustments (e.g., the point of transaction system 218 can send a final ping to the issuer account system 214 in response to expiration of a predetermined period of time to determine if there were any final tip adjustments). Specifically, the dynamic digital tip system 100 receives one or more modifications to an initial digital tip amount and sends (e.g., via the issuer account system 214) the modifications to the point of transaction system 218 to process. For instance, the dynamic digital tip system 100 utilizes the point of transaction system 218 to process the final digital tip in response to expiration of a predetermined period of time.

Furthermore, FIG. 2 shows the dynamic digital tip system 100 performing an act 222 of generating a batch of transactions for the merchant (e.g., the merchant associated with the point of transaction system 218). Specifically, the act 22 of generating a batch of transactions includes the dynamic digital tip system 100 utilizing the point of transaction system 218 to aggregate digital transactions for a specific period of time (e.g., the last 24 hours) and to send that aggregated data over to the issuer account system 214.

In one or more embodiments, the dynamic digital tip system 100 leverages batching delays. Specifically, as mentioned above, the dynamic digital tip system 100 generates a batch of transactions (e.g., an aggregate of digital transactions for a specific period of time) and delays processing the entire batch of transactions utilizing the point of transaction system 218. In some embodiments, the dynamic digital tip system 100 utilizes the point of transaction system 218 to generate a batch that includes a subset of digital transactions (e.g., a subset of a plurality of digital transactions that have gone through the point of transaction system 218 but that have not been settled yet).

For instance, the dynamic digital tip system 100 batches together the subset of digital transactions based on similar characteristics (e.g., certain product types, certain services, etc.). Thus, the dynamic digital tip system 100 can delay processing a batch of a subset of digital transactions and proceed with processing another batch that includes a different subset of digital transactions. Accordingly, the dynamic digital tip system 100 can provide an initial adjustment window for a subset of digital transaction before further delays (e.g., in processing) are introduced to the point of transaction system 218.

FIG. 2 shows the dynamic digital tip system 100 sending the aggregated batch of digital transactions to the issuer account system 214, and the dynamic digital tip system 100 further performs an act 224 of finalizing capture of digital transactions (e.g., for a specific merchant). Furthermore, FIG. 2 shows the dynamic digital tip system 100 sending the finalized capture of digital transactions to a merchant account system 226 that is linked to the point of transaction system 218. Specifically, the merchant account system 226 refers to a financial transaction system that processes credit and debit card payments on behalf of a merchant. For instance, the merchant account system 226 acts as an intermediary between the merchant and the issuer account system 214. To illustrate, the dynamic digital tip system 100 utilizes the merchant account system 226 to facilitate the transfer of funds from a user account of the issuer account system 214 to the merchant's account (e.g., the merchant of the point of transaction system 218).

Moreover, FIG. 2, shows that in response to sending the finalized capture of digital transactions to the merchant account system 226, the dynamic digital tip system 100 further utilizes the merchant account system 226 to perform an act 228 of settling the digital transaction 204. In one or more embodiments, settling the digital transaction 204 refers to a completion of the process of finalizing and receiving digital funds for the digital transaction amount 206 and an initial digital tip amount (e.g., of the initial digital tip 208). Specifically, settlement occurs after authorization and capture of digital transactions and involves transferring funds from the issuer account system 214 to the merchant account system 226. In other words, the merchant of the point of transaction system 218 actually receives the payment associated with the digital transaction 204 in their digital bank account.

As mentioned above, FIG. 3 provides additional details regarding the dynamic digital tip system 100 utilizing contextual merchant metadata. As shown, FIG. 3 illustrates an example diagram of the dynamic digital tip system 100 receiving contextual merchant metadata and utilizing the contextual merchant metadata to determine data about a merchant in accordance with one or more embodiments.

For example, FIG. 3 shows the dynamic digital tip system 100 receiving contextual merchant metadata 305 as part of an authorization request 302. Specifically, as highlighted above, the dynamic digital tip system 100 receives the authorization request 202 and transmits the authorization request 202 to the issuer account system 214. For instance, the dynamic digital tip system 100 integrates the issuer account system 214 with the dynamic digital tip manager 116 and extracts the contextual merchant metadata 305 via the integration. To illustrate, the dynamic digital tip system 100 receives an identifier 307 (e.g., an identifier that is part of the unique identifier 210 discussed in FIG. 2 or an identifier separate from the unique identifier 210) as part of the authorization request 302, where at least a part of the identifier 307 points to a specific merchant source (e.g., a point of transaction system). Based on the specific merchant source, the dynamic digital tip system 100 can extract/identify the contextual merchant metadata 305 from one or more database systems.

As shown in FIG. 3, the dynamic digital tip system 100 can utilize the dynamic digital tip manager 116 to transmit a request (e.g., ping) third-party data sources 306. Specifically, the dynamic digital tip system 100 utilizes the identifier 307 to transmit the request to the third-party data sources 306. By using the identifier 307, the dynamic digital tip system 100 parses the third-party data sources 306 for data specifically related to the merchant of the identifier 307.

In one or more embodiments, the dynamic digital tip system 100 obtains the contextual merchant metadata 305 from the third-party data sources 306. For example, third-party data sources 306 refer to data sources not authorized or internal to the merchant of a point of transaction system. Specifically, the third-party data sources 306 can originate from digital public forums that provide information regarding employee tip impact for a specific merchant, tipping norms, and specific merchant practices. To illustrate, the dynamic digital tip system 100 parses digital sources relating to a specific merchant (e.g., and/or a specific location of the merchant) to determine relevant tipping information to assist the client device of the user account in providing a tip. For instance, the dynamic digital tip system 100 interfaces (e.g., an application programming interface) with one or more digital public forums (e.g., third parties) to obtain the information relevant to the identifier 307.

As shown in FIG. 3, in one or more embodiments, the dynamic digital tip system 100 can determine employee tip impact 310 for a specific merchant. Specifically, the employee tip impact 310 refers to the effect that digital tips received by employees have on various aspects of their compensation and the employer's obligations. For instance, some employees earn wages where a digital tip makes up a significant portion of their income (e.g., the dynamic digital tip system 100 determines pooled versus direct, salary-based tips, employee versus owner distribution, etc.). For example, some merchants have direct tipping, while other merchants have pooled tipping. In particular, direct tipping indicates that a digital tip goes directly to a specific service worker. In contrast, pooled tipping indicates that a digital tip is split amongst multiple service workers.

Furthermore, in some embodiments, the dynamic digital tip system 100 can determine tipping norms 312 for a type of merchant (e.g., from the third-party data sources 306). Specifically, the tipping norms 312 for a type of merchant includes a customary or socially accepted digital tipping amount for a type of good or service. For instance, for restaurants, the tipping norms 312 typically include a 15%-20% digital tip; for ride services, the tipping norms 312 typically include a 10-20% digital tip; for delivery services, the tipping norms 312 typically include a 10-15% digital tip; and for salon and spa services, the tipping norms 312 typically include a 15-20% digital tip. In other words, the tipping norms 312 vary in different goods and services contexts. Thus, the dynamic digital tip system 100 determines the tipping norms 312 for a specific merchant based on the type of merchant it is.

In one or more embodiments, the dynamic digital tip system 100 receives the identifier 307 (e.g., Austin's Pizza) and determines that it is a merchant type of restaurant. In some embodiments, the dynamic digital tip system 100 utilizes the identifier 307 of the dynamic digital tip system 100 to intelligently parse the third-party data sources 306 and determine the merchant type. In some embodiments, the dynamic digital tip system 100 utilizes the identifier 307 and uses a trained machine learning model (e.g., trained on ground truth data of actual merchant types) to predict a merchant type and corresponding tipping norms.

In addition, in one or more embodiments, the dynamic digital tip system 100 determines merchant practices 314 from the third-party data sources 306. Specifically, the merchant practices 314 can indicate working conditions, employee satisfaction, and general practices of a merchant. For example, the merchant practices 314 can indicate that a specific merchant typically deducts digital tips given to service workers (e.g., merchant greed). Accordingly, the dynamic digital tip system 100 can leverage the third-party data sources 306 to determine a variety of data that falls under the umbrella of the contextual merchant metadata 305.

As further shown in FIG. 3, the dynamic digital tip system 100 further utilizes the dynamic digital tip manager 116 to extract data from internal data sources 308 (e.g., a data source that allows employers and employees to input data about compensation practices at specific locations, where the data source is not expressly sanctioned by a merchant). In one or more embodiments, the dynamic digital tip system 100 obtains the contextual merchant metadata from internal data sources. For example, an internal data source refers to an internally authorized source of data (e.g., internally authorized by a merchant of a point of transaction system) that provides information regarding employee tip impact, tipping norms, and merchant practices. Specifically, the merchant of the point of transaction system integrates with the dynamic digital tip system 100 to directly provide the contextual merchant metadata 305. To illustrate, a merchant transparently provides to the dynamic digital tip system 100 internal employee tip impact 316 data, internal merchant practice 318 data, and QR code data 320.

In one or more embodiments, the internal employee tip impact 316 data is analogous to the employee tip impact 310 described above, however the data (e.g., pooled tip or direct tip) is directly provided by the merchant. Further, in some embodiments, the internal merchant practices 318 is analogous to the merchant practices 314 described above, however the data is also directly provided by the merchant.

In one or more embodiments, the QR code data 320 refers to an integration of the merchant with the dynamic digital tip system 100. Specifically, the integration causes a point of transaction terminal device to print a receipt for a client device or to send a digital receipt to a client device (e.g., after the digital transaction has been approved by an issuer account system). For instance, the digital receipt (or receipt) includes a QR code with the QR code data 320 that includes the contextual merchant metadata 305 (e.g., a client device can scan the QR code and receive data about the internal employee tip impact 316, the tipping norms 312, online review about a merchant, and/or the internal merchant practices 318).

In one or more embodiments, the dynamic digital tip system 100 can further process a digital or physical receipt of a digital transaction even if the merchant does not have an integration with the dynamic digital tip system 100 (e.g., there is no QR code data). For example, the dynamic digital tip system 100 can allow a client device to capture a digital image of the receipt for the digital transaction and the dynamic digital tip system 100 uses optical character recognition techniques to separate charges into services, taxes, and tips. In doing so, the dynamic digital tip system 100 can utilize this information to provide a suggestion for a digital tip. Furthermore, the dynamic digital tip system 100 stores the digital image of the receipt as documentation for disputes over tip adjustments with merchants.

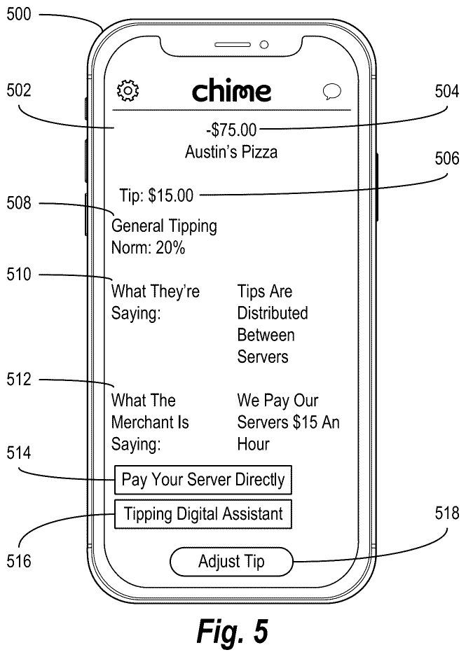

Thus, FIG. 3 illustrates the dynamic digital tip system 100 extracting the contextual merchant metadata 305 for a specific merchant, and FIG. 5 provides additional context for how the dynamic digital tip system 100 provides that data to a client device to make an informed decision regarding digital tipping.

Although FIG. 3 describes the dynamic digital tip system 100 receiving the authorization request 302 and then extracting the contextual merchant metadata 305, in some embodiments, the dynamic digital tip system 100 directly receives the contextual merchant metadata 305 from the authorization request 302. Specifically, along with the digital transaction, the dynamic digital tip system 100 utilizes the point of transaction system to further transmit a data payload with the authorization request that includes the internal employee tip impact 316, the internal merchant practices 318, etc.

As mentioned above, the dynamic digital tip system 100 further utilizes contextual tip metadata for a user account to provide one or more suggestions for a digital tip. FIG. 4 illustrates the dynamic digital tip system 100 determining contextual tip metadata for a user account user by using user account preferences and/or machine learning techniques in accordance with one or more embodiments.

As shown in FIG. 4, the dynamic digital tip system 100 accesses contextual tip metadata 402. In one or more embodiments, part of the contextual tip metadata 402 includes user preferences. For example, a client device of a user account can preset global user account preferences 416 and/or local user account preferences 418 for digital tipping practices. For example, the global user account preferences 416 refers to universal preferences for digital tipping. Specifically, the client device of the user account can indicate that they always want to tip 15%, regardless of the type of merchant. Furthermore, the client device of the user account can indicate that they want to tip 20% if their account balance is over $20,000 or that they want to tip 15% if their account balance is under $20,000.

In one or more embodiments, the local user account preferences 418 refers to specific indications for digital tipping. Specifically, the client device of the user account can indicate that they want to tip 15% for pizza restaurants and tip 25% for fine dining restaurants.

As further shown in FIG. 4, the dynamic digital tip system 100 further utilizes a machine learning model 410. As used herein, the term “machine learning model” refers to a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

As shown in FIG. 4, the dynamic digital tip system 100 utilizes the machine learning model 410 to process user account preferences 404, user account history 406, and account data 408. In other words, the dynamic digital tip system 100 utilizes budget limits, available funds, and predicted end of month funds to provide one or more digital tip predictions. In one or more embodiments, user account preferences 404 refers to settings established by a client device of a user account such as the global user account preferences 416 and the local user account preferences 418. Further, in some embodiments, user account history 406 refers to past behavior by a client device of a user account. Specifically, the user account history 406 indicates that past digital transactions and the digital tip amounts.

Moreover, in some embodiments, the account data 408 indicates relevant data of a user account for financial transactions. Specifically, the account data 408 includes an amount of money in a checking account, an amount of money in a savings account, when specific types of bills are subtracted from a bank account, spending behavior of a user account, and additional information related to financial transactions/spending data.

As shown in FIG. 4, the dynamic digital tip system 100 generates a digital tip predictions by processing the user account preferences 404, the user account history 406, and the account data 408. In one or more embodiments, the dynamic digital tip system 100 leverages the machine learning model predictions to assist a client device of a user account. For example, the machine learning predictions can include a global digital tip prediction 412 (e.g., you should tip 18%) or a merchant specific digital tip prediction 414 (e.g., for restaurant X tip 15% for restaurant Y tip 20%).

In one or more embodiments, the dynamic digital tip system 100 trains a machine learning model to optimize/generate parameters for a dynamic digital tip machine learning model. Specifically, the dynamic digital tip system 100 utilizes a training dataset containing a plurality of data (e.g., user account preferences, user account history, account data) and further uses the machine learning model to generate a prediction. For instance, the dynamic digital tip system 100 compares the prediction with a ground truth set of example data (e.g., the example data includes a set of user account preferences, user account history, account data, and an optimal amount to provide as a digital tip based on the example data). Further, the dynamic digital tip system 100 generates both global predictions and merchant specific predictions (e.g., for major merchants) and compares these predictions to a ground truth set of example data. From the comparison of predictions with ground truth data, the dynamic digital tip system 100 further modifies parameters of the machine learning model (e.g., based on a measure of loss).

Furthermore, although FIG. 4 shows the dynamic digital tip system 100 utilizing the machine learning model 410 to process the user account preferences 404, the user account history 406, and the account data 408, in one or more embodiments, the dynamic digital tip system 100 further utilizes the machine learning model 410 to process the data shown in FIG. 3 (e.g., the third-party data sources 306 and the internal data sources 308) to further generate a machine learning prediction.

As mentioned above, a client device of a user account can view account data and select an option to modify a digital tip that was part of an earlier digital transaction. FIG. 5 illustrates an example graphical user interface of the dynamic digital tip system 100 providing an option to modify a digital tip. For example, FIG. 5 shows the dynamic digital tip system 100 providing to a client device 500 via a graphical user interface 502 a contextual tipping user interface.

In one or more embodiments, the dynamic digital tip system 100 intelligently leverages data obtained from various systems (e.g., the point of transaction system and the issuer account system) to provide suggestions to a client device of a user account for paying a digital tip. Specifically, the dynamic digital tip system 100 draws from the contextual merchant metadata and the contextual tip metadata to provide one or more suggestions for the client device of the user account to leave a digital tip. For instance, the dynamic digital tip system 100 extracts contextual merchant metadata from third-party data sources and/or internal data sources (e.g., using the dynamic digital tip manager 116), identifies global/local user account preferences, and further generates machine learning predictions for digital tips.

In some embodiments, the dynamic digital tip system 100 provides the extracted, identified, and generated data for digital tips directly to the graphical user interface 502 of the client device 500. As shown in FIG. 5, the dynamic digital tip system 100 displays on the graphical user interface 502 a digital transaction amount 504 (e.g., $75.00 for Austin's Pizza), a digital tip amount (e.g., $15.00), a tipping norm 508 (e.g., 20%), contextual merchant metadata from third-party data sources 510 (e.g., tips are distributed between servers), and contextual merchant metadata from internal data sources 512 (e.g., we pay our servers $15 an hour). Thus, a client device can utilize the extracted and identified data to determine whether they want to modify the digital tip 506.

Additionally, FIG. 5 shows an element 514 to pay your server directly (e.g., direct tip routing). In some embodiments, the element 514 to pay your server directly allows you to directly transmit a digital tip to a service worker. Specifically, the dynamic digital tip system 100 integrates with the merchant and allows for service workers of the merchant to share account data for personal payment accounts. For instance, selecting the element 514 allows the client device 500 to send a direct digital tip, effectively bypassing the merchant or any other middleman. To illustrate, the point of transaction system can indicate which service worker is working during certain hours and the dynamic digital tip system 100 transmits that information when sending an authorization request to an issuer account system.

In some embodiments, selecting the element 514 provides the client device 500 with the personal payment account information of a service worker. In some embodiments, selecting the element 514 allows the client device 500 to directly pay the service worker, but the dynamic digital tip system 100 masks the personal payment account information.

As shown in FIG. 5, the dynamic digital tip system 100 further provides a tipping digital assistant element 516. Specifically, selecting the tipping digital assistant element 516 causes the graphical user interface 502 to transition to a digital tipping assistant interface. For example, the digital tipping assistant interface shows a suggested tip amount for the client device 500 to provide/modify. For instance, the dynamic digital tip system 100 utilizes a trained machine learning model to generate the digital tip prediction (e.g., as described above in FIG. 4) and uses that prediction to provide a suggested tip amount to the client device 500. Specifically, the dynamic digital tip system 100 generates the suggested tip amount by drawing from the contextual tip metadata and the contextual merchant metadata (e.g., the client device 500 can establish tipping thresholds that account for up-and-coming bills and expected deposits, and the dynamic digital tip system 100 utilizes this as the contextual merchant metadata). In other words, the dynamic digital tip system 100 intelligently determines an amount that suits a client device of a user account.

Furthermore, in some embodiments, the dynamic digital tip system 100 causes the tipping digital assistant interface to further display sources from which the suggestions/information originate from. For example, the dynamic digital tip system 100 provides a transparency notice that indicates the source of information (e.g., crowdsourced information or internally verified information).

In some embodiments, rather than showing the tipping digital assistant element 516, the dynamic digital tip system 100 shows the digital tipping assistant data in the graphical user interface 502 (e.g., shows all the information within a single graphical user interface). Moreover, FIG. 5 shows the dynamic digital tip system 100 providing an adjust tip element 518, and in response to a selection of the adjust tip element 518 the dynamic digital tip system 100 provides an option to submit an amount of the digital tip. For instance, the dynamic digital tip system 100 allows a user to select one or more suggested tip amounts to submit as an adjusted tip.

In one or more embodiments, the tipping digital assistant interface further provides automated tipping information such as tipping decisions based on learned preferences. For example, the learned preferences can include a tip average (e.g., based on the activity of the user account), a minimize tip expense (only tip for restaurants and not any fast-food chains), or tip to impress (e.g., give an upper limit digital tip (30%) for higher end restaurant joints).

Furthermore, in response to the dynamic digital tip system 100 receiving an adjustment to the digital tip 506, the dynamic digital tip system 100 further causes the graphical user interface to transition to a tip adjustment reason interface. For instance, the dynamic digital tip system 100 causes the tip adjustment reason interface to display a reason checklist that includes a checklist or a dropdown menu where the client device can select a reason for adjusting the digital tip 506. Specifically, the dynamic digital tip system 100 can display options such as “service was better/worse than expected,” “initially entered wrong amount,” or “reflecting on service quality.”

Moreover, in some embodiments, the dynamic digital tip system 100 further provides an option for the client device to provide feedback to the merchant (e.g., of a point of transaction system for the digital transaction of Austin's Pizza). In some embodiments, the dynamic digital tip system 100 utilizes an issuer account system to transmit the feedback along with the tip adjustment to a point of transaction system. Further, in some embodiments, the dynamic digital tip system 100 draws from the feedback data to provide additional assistance/context to other client devices for digital tipping practices.

As discussed above, the dynamic digital tip system 100 receives a submission of a modification to a digital tip (e.g., and in some embodiments the tip adjustment reason), and transmits (e.g., via the dynamic digital tip manager 116) the modified digital tip to an issuer account system, which in turn transmits (e.g., via the dynamic communication channel) the modified digital tip to a point of transaction system. For instance, the dynamic digital tip system 100 can continually transmit modifications to a digital tip amount until the expiration of a predetermined period of time.

Although not shown in FIG. 5, in one or more embodiments, the dynamic digital tip system 100 further causes the graphical user interface 502 to display a time element that indicates a countdown timer showing the remaining time to adjust the digital tip. Furthermore, although FIG. 5 shows the adjust tip element 518 as a button, in one or more embodiments, the dynamic digital tip system 100 provides the adjust tip element 518 as a sliding element. For instance, the dynamic digital tip system 100 causes the graphical user interface 502 to display the initial tip of $15 as part of a sliding element and allows a client device to slide the $15 up (e.g., increase the tip) or down (e.g., decrease the tip). Further, in some embodiments, the dynamic digital tip system 100 provides the adjust tip element 518 as a numeric entry. For instance, the dynamic digital tip system 100 causes the graphical user interface 502 to display an empty box where the client device can manually enter a tip amount.

Furthermore, in one or more embodiments, the dynamic digital tip system 100 further identifies a geographic region associated with a digital transaction. Specifically, the dynamic digital tip system 100 identifies the geographic region, and further identifies applicable legal and compliance regulations regarding digital tip adjustments and the handling of electronic payments. In doing so, the dynamic digital tip system 100 ensures that dynamic digital tip adjustment options are provided to client devices in compliance with the applicable laws and regulations.

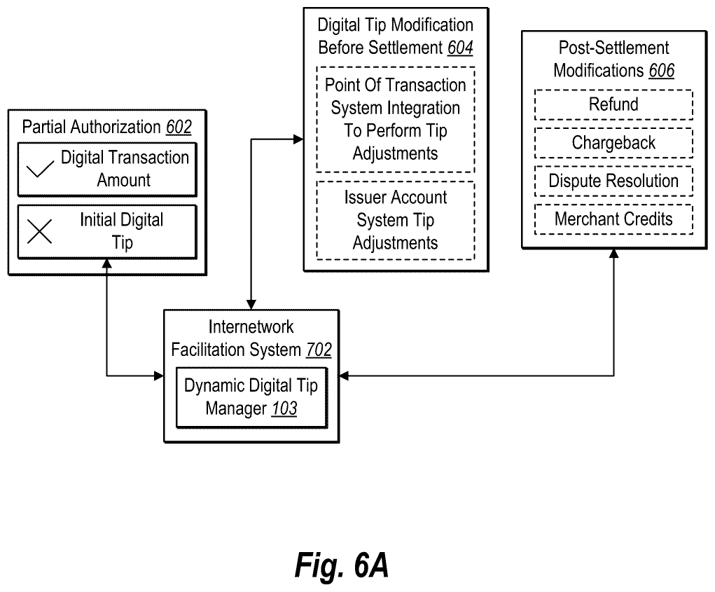

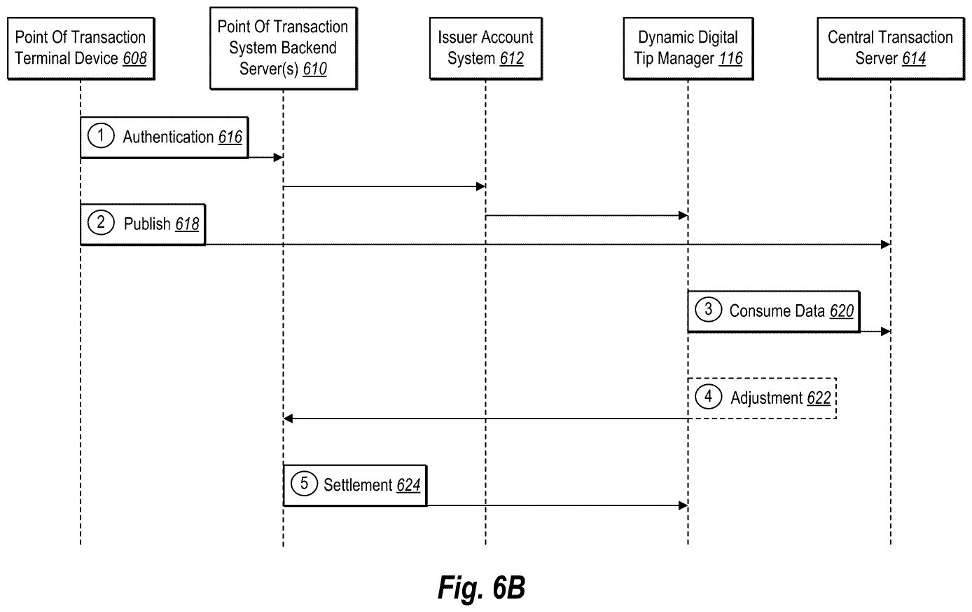

As mentioned above, the dynamic digital tip system 100 provides a variety of methods/processes for modifying an initial digital tip. FIG. 6A illustrates the dynamic digital tip system 100 providing partial authorization, digital tip modification before settlement, and post-settlement modifications to perform dynamic tip modification in accordance with one or more embodiments.

FIG. 6A shows a partial authorization 602 of a digital transaction. For example, the partial authorization 602 refers to the dynamic digital tip system 100 only authorizing the digital transaction amount (e.g., Austin's Pizza for $75.00) and not authorizing an initial digital tip. Specifically, the dynamic digital tip system 100 performs partial authorization 602 by utilizing the point of transaction system to transmit an authorization request to an issuer account system, and the dynamic digital tip system 100 further causes the issuer account system to not approve the initial digital tip but approve the digital transaction amount.

In other words, the dynamic digital tip system 100 utilizes the partial authorization 602 to remove the social pressure of providing a digital tip on the spot. For instance, regardless of the amount of digital tip indicated by a client device, the dynamic digital tip system 100 does not send the digital tip for processing. Rather, the dynamic digital tip system 100 allows the client device to add on a digital tip after the digital transaction amount has been authorized. In some embodiments, the dynamic digital tip system 100 pings the client device to remind them that they can add a digital tip amount for a specific merchant. Further, in some embodiments, the dynamic digital tip system 100 can remind the user when the predetermined period of time is almost expired.

As shown in FIG. 6A, the dynamic digital tip system 100 can perform digital tip modification before settlement 604. For example, the digital tip modification before settlement 604 refers to the dynamic digital tip system 100 causing the full authorization of the digital transaction amount and the initial digital tip. However, the dynamic digital tip system 100 utilizes the issuer account system to delay the point of transaction system from processing the initial digital tip (for a predetermined period of time). Specifically, the dynamic digital tip system 100 utilizes the dynamic digital tip manager to provide an option to a client device to modify the initial digital tip that was already authorized but not yet finalized.

As shown, the digital tip modification before settlement 604 can include a point of transaction system integration to perform tip adjustments. In other words, the dynamic digital tip system 100 can utilize the dynamic digital tip manager 116 to directly integrate with the point of transaction system, which is discussed in more detail below in FIG. 6B. Further, the dynamic digital tip system 100 can utilize issuer account system tip adjustments. For instance, the dynamic digital tip system 100 collaborates with the issuer account system to allow for issuer driven adjustments (e.g., the issuer account system communicates with the point of transaction system in response to a modification by a client device).

Furthermore, FIG. 6A shows post-settlement modifications 606 (e.g., fallback methods). Specifically, if a client device fails to adjust/modify a digital tip within a predetermined period of time, the dynamic digital tip system 100 still allows a client device to perform the post-settlement modifications 606. For example, the dynamic digital tip system 100 can receive a request from a client device for a refund, the dynamic digital tip system 100 can send a chargeback to the point of transaction system (e.g., in response to a request form a client device), the client device can submit a dispute resolution request, or the point of transaction system can give a client device merchant credits (e.g., in response to a dispute of a digital transaction).

As mentioned above, FIG. 6B describes the direct integration of the point of transaction system with the dynamic digital tip system 100. As shown in FIG. 6B, the dynamic digital tip system 100 utilizes a point of transaction terminal device 608 to perform an act 616 of sending an authentication request to a point of transaction system backend server(s) 610, and the point of transaction system backend server(s) 610 subsequently sends the authentication request to an issuer account system 612. Further, FIG. 6B shows the dynamic digital tip system 100 utilizing the dynamic digital tip manager 116 to access data from the authentication request from the issuer account system 612.

In one or more embodiments, the dynamic digital tip system 100 integrates directly with the point of transaction system by causing a point of transaction system to generate a uniform resource identifier. For example, a uniform resource identifier (URI) refers to a string of characters used to identify a specific digital transaction. In other words, the URI indicates a resource by location and/or name. Specifically, the dynamic digital tip system 100 causes the point of transaction system to generate an adjustment URI for a digital transaction and includes the adjustment URI in the transaction receipt (e.g., digital or physical).

As shown in FIG. 6B, the dynamic digital tip system 100 causes a point of transaction terminal device 608 to perform an act 618 of publishing the adjustment URI to a central transaction server 614 (e.g., transaction processing system). For instance, the dynamic digital tip system 100 accesses data from the issuer account system 612 that indicates that the point of transaction system has generated an adjustment URI and published it to the central transaction server 614. As further shown, the dynamic digital tip system 100 then utilizes the dynamic digital tip manager 116 to perform an act 620 of consuming the data (e.g., the adjustment URI) published on the central transaction server 614.

In some embodiments, the dynamic digital tip system 100 utilizes the dynamic digital tip manager 116 to monitor the central transaction server 614. Specifically, the dynamic digital tip system 100 utilizes the dynamic digital tip manager 116 to periodically consume data from the central transaction server 614. In some instances, the dynamic digital tip system 100 utilizes the dynamic digital tip manager 116 to consume data from the central transaction server 614 every time data is published to it.

As further shown, in response to any adjustments (e.g., an act 622 of adjusting a digital tip) made by a client device to digital transactions on the central transaction server 614 (e.g., via the dynamic digital tip manager 116), the dynamic digital tip system 100 utilizes the dynamic digital tip manager 116 to further transmit a data payload (regarding the adjustment to the digital tip) back to the point of transaction system backend server(s) 610. Furthermore, the dynamic digital tip system 100 then utilizes the point of transaction system backend server(s) 610 to perform an act 624 of settlement (e.g., finalizing and settling the digital transaction that includes the adjusted digital tip).

In one or more embodiments, the dynamic digital tip system 100 causes the point of transaction system to send the adjustment URI to a client device (e.g., via the receipt) and allows a client device to select the URI for one or more digital tip adjustments. For instance, the dynamic digital tip system 100 causes the point of transaction system to generate the adjustment URI, where the adjustment URI has a preset time (e.g., 24 hours) to access the URI and make adjustments. In some embodiments, in response to a selection of the adjustment URI by the client device, a client application of the dynamic digital tip system 100 decodes the URI metadata and presents the client device with adjustment options. Further, in some embodiments, in response to a selection of an adjustment option by the client device, the dynamic digital tip system 100 transmits a data payload (e.g., that includes the tip adjustment and any other relevant information, such as a digital receipt and reasons for adjustment) to the point of transaction system backend server(s) 610 of the point of transaction system.

In one or more embodiments, the dynamic digital tip system 100 generates the central transaction server 614 for one or more point of transaction systems to publish digital transaction data (e.g., adjustment URIs). Specifically, the following pseudocode represents the dynamic digital tip system 100 generating the central transaction server 614:

```
{
  “transactionId”: “authCode123”, // Authorization code or similar identifier that ties a digital
transaction of a point of transaction system to an issuer account system (e.g., an issuer bank of
the client device)
  “authorizationAmount”: 10000, // in cents, as the number in cents assists the dynamic digital
tip system 100 in finding the transaction in the central transaction server 614 (assuming 100.00
USD)
  “initialTip”: 500, // in cents
  “transactionTimestamp”: “2023-12-01T14:30:00Z”, // Timestamp of the transaction
  “adjustmentWindow”: 24, // in hours
  “adjustmentEndpoint”: {
    “uiUrl”: “tipadjusterXXXXX”, // selection of the uiUrL can cause a client application of a
client device to launch
    “url”: “api.pointoftransactionsystem.com/v1/payments/{paymentGuid}/tip”,
    “headers”: {
      “Authorization”: “Bearer {your_api_token}”,
      “Content-Type”: “application/json”
    },
    “payloadTemplate”: {
      “tipAmount”: 500 // Placeholder for the new tip amount in cents (e.g., $5.00)
    }
  }
}
```

The above pseudocode illustrates that the dynamic digital tip system 100 transmits a transaction identifier, an authorization amount, an initial tip, a transaction timestamp, an adjustment window and an adjustment endpoint to a client device. In response to a selection of an adjustment URI, the dynamic digital tip system 100 causes a client application on the client device to launch and provide an option for modifying a digital tip.

Furthermore, the below pseudocode illustrates the dynamic digital tip system 100 submitting an adjustment using a protocol of the central transaction server 614:

curl -X POST “api.pointoftransactionsystem.com/v1/payments/{paymentGuid}/tip” \
-H “Authorization: Bearer {your_api_token}” \
-H “Content-Type: application/json” \
-d ‘{
“tipAmount”: 700 // The new tip amount in cents (e.g., $7.00)
}’

In the above pseudocode, the dynamic digital tip system 100 utilizes the dynamic digital tip manager 116 to send a request to the specified endpoint, such as the point of transaction system backend server(s) 610.

The following description includes a typical flow of the dynamic digital tip system 100 based on the principles discussed above. In one or more embodiments, the dynamic digital tip system 100 begins with a transaction process where a client device adds a digital tip and signs a digital receipt during a digital transaction. In some instances, the client device captures a digital image of the receipt post-purchase (e.g., a screenshot of the receipt or a digital image of the physical receipt). Further, the dynamic digital tip system 100 integrates the receipt image with the digital transaction details using optical character recognition techniques to identify product costs, taxes and tips.

Furthermore, in some embodiments, the dynamic digital tip system 100 then provides tip adjustment features. For example, the dynamic digital tip system 100 provides an adjust tip element in the graphical user interface of the client device which is available for a predetermined period of time (e.g., 24 hours post-transaction), which allows the client device to modify their digital tip amount. For instance, the dynamic digital tip system 100 can receive adjustments to the digital tip through the provided interface, where the client device can increase or decrease the digital tip based on their experience. In response to receiving an adjustment from the client device, the dynamic digital tip system 100 handles the backend processes, including the necessary documentation and bank communications (e.g., the issuer account system and the merchant account system).

In some embodiments, as mentioned above, the dynamic digital tip system 100 provides a digital tip assistant interface (e.g., an educational profile) regarding the tip usage at the establishment where the digital transaction took place, potentially influencing the client device in adjusting the digital tip. Furthermore, for each tip adjustment, the dynamic digital tip system 100 sends a request to an issuer account system and a point of transaction system accompanied by a copy of the digital receipt. Moreover, the request for tip adjustment can further include a statement (e.g., from the client device) explaining a reason for the adjustment to the digital tip. Additionally, in some embodiments, the dynamic digital tip system 100 provides an interface for a client device to view the total amount of digital tips adjusted over time.

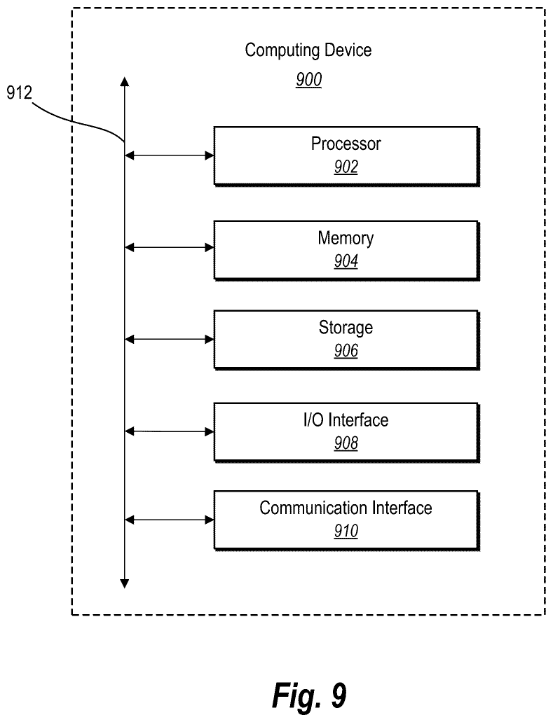

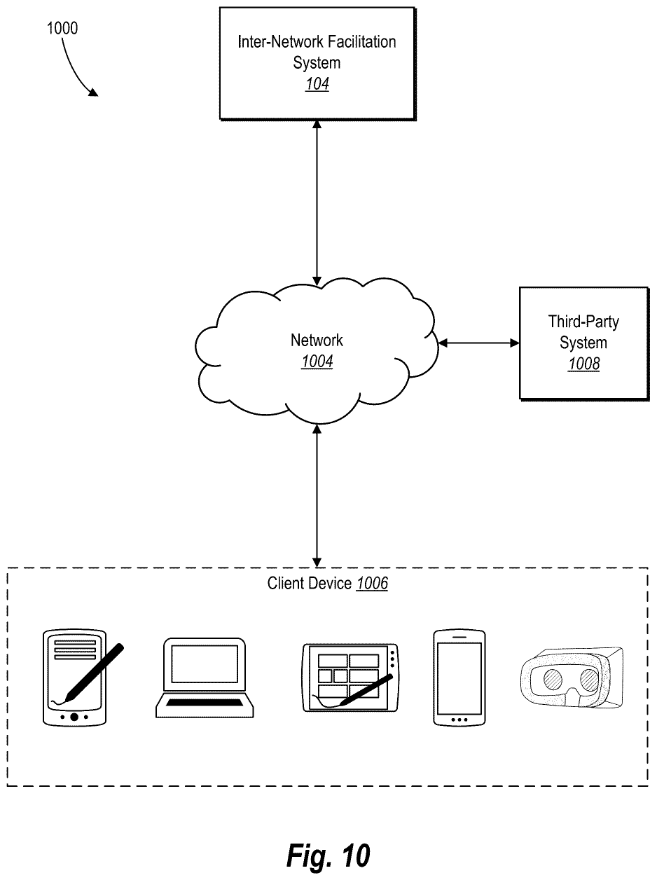

Additional detail regarding the dynamic digital tip system 100 will now be provided with reference to the figures. In particular, FIG. 7 illustrates a block diagram of a system environment for implementing the dynamic digital tip system 100 in accordance with one or more embodiments. As shown in FIG. 7, the environment includes server(s) 706 implementing the dynamic digital tip system 100 as a dynamic digital tip manager 116 as part of the inter-network facilitation system 702. The environment of FIG. 7 further includes a client device 708, a device application, a transaction processing system 710, a merchant account system 712, an issuer account system 714, and a point of transaction system 716. The server(s) 706 can include one or more computing devices to implement the dynamic digital tip system 100. Additional description regarding the illustrated computing devices (e.g., the server(s) 706, the client device 708, client devices of the transaction processing system 710, the merchant account system 712, the issuer account system 714, and the point of transaction system 716) is provided with respect to FIGS. 9-10 below.

As shown, the dynamic digital tip system 100 utilizes the network 707 to communicate with the client device 708. The network 707 may comprise a network as described in relation to FIGS. 9-10. For example, the dynamic digital tip system 100 communicates with the client device 708 to provide and receive information pertaining to various digital transactions, digital transaction amounts, and initial digital tip amounts and communicates with the dynamic digital tip manager 116 for providing an option to modify one or more initial digital tip amounts. Indeed, the dynamic digital tip system 100 can generate a final digital tip in response to a modification of an initial digital tip by the client device 708.

As described in greater detail below (e.g., in relation to FIG. 9), the inter-network facilitation system 702 can manage interactions across multiple devices, providers, and computer systems. For example, the inter-network facilitation system 702 can execute transactions across various third-party systems such as a banking entity, automated transaction machines, or payment providers. The inter-network facilitation system 702 can also maintain and manage digital accounts for client devices/users to store, manage, and/or transfer funds to other users.

To facilitate modifying an initial digital tip amount, in some embodiments, the inter-network facilitation system 702 or the dynamic digital tip system 100 communicates with the dynamic digital tip manager 116. More specifically, the inter-network facilitation system 702 or the dynamic digital tip system 100 determines the identity and permissions of the client device 708 by communicating with a secured account management system. The dynamic digital tip system 100 can determine permissions of the client device 708 prior to disclosing secure information to the client device 708. For example, the inter-network facilitation system 702 or the dynamic digital tip system 100 accesses a secured account maintained by the secured account management system (e.g., remotely from the server(s) 706) and determines the digital transactions and digital tips within the secured account and further allows the client device 708 to modify the initial digital tip.

In one or more embodiments, the inter-network facilitation system 702 communicates with the secured account management system in response to receiving identification information from the client device 708. In particular, the inter-network facilitation system 702 provides an indication of a secured account associated with a digital account to indicate that the client device 708 is authorized to receive information pertaining to the digital account. In addition, the inter-network facilitation system 702 communicates with the secured account management system to determine permissions of the client device 708. For example, the inter-network facilitation system 702 provides information to the client device 708 such as suggested digital tip amounts, current balance information, dispute resolution status, direct deposit status, transaction information, digital account updates, device fee information, check status, interaction history, transaction status, activation, etc.

As mentioned above, the client device 708 includes a device application. In particular, the device application can include a web application, a native application installed on the client device 708 (e.g., a mobile application, a desktop application, etc.), or a cloud-based application where all or part of the functionality is performed by the server(s) 706. In some embodiments, the inter-network facilitation system 702 or the dynamic digital tip system 100 communicates with the client device 708 through the device application. This communication for example, receives and provides account information and transaction information including, recent digital tips (e.g., that are still within the predetermined period of time), suggested modifications to digital tips, direct deposit status, digital account updates, device fee information, check status, interaction history, transaction status, activation, etc. As shown, the dynamic digital tip system 100 can provide digital account information and secured account information for display within a graphical user interface associated with the device application.

As shown in FIG. 7, the client device 708 implements the device application in conjunction with interaction with the inter-network facilitation system 702 or the dynamic digital tip system 100 (e.g., the dynamic digital tip manager 116). For example, the inter-network facilitation system 702 or the dynamic digital tip system 100 can monitor the activities of the device application. In particular, these activities can include events such as time spent on device application, recently viewed pages on device application, recently viewed transaction on the device application, history of digital tips, attempted dispute requests, current spending habits, etc.

As shown in FIG. 7 and as discussed above, the dynamic digital tip system 100 can utilize the point of transaction system 716 to transmit an authorization request for a digital transaction to the issuer account system 714 via the network 707 by using the transaction processing system 710. Specifically, each of the point of transaction system 716, the issuer account system 714, and the merchant account system 712 interface with the transaction processing system 710 which is reached by first going through the network 707. Further, the issuer account system 714 keeps a dynamic communication channel open with the point of transaction system 716 via the network and specifically via the transaction processing system 710. Moreover, upon finalizing a batch of digital transactions, the issuer account system 714 can send digital funds to the merchant account system 712 via the network 707 (e.g., the transaction processing system 710.

Although FIG. 7 illustrates the environment having a particular number and arrangement of components associated with the dynamic digital tip system 100, in some embodiments, the environment may include more or fewer components with varying configurations. For example, in some embodiments, the inter-network facilitation system 702 or the dynamic digital tip system 100 can communicate directly with the client device 708, the transaction processing system 710, the merchant account system 712, the issuer account system 714, the point of transaction system 716, the device application, and/or the secured account management system, bypassing the network 707. In these or other embodiments, the inter-network facilitation system 702 or the dynamic digital tip system 100 can be implemented (entirely on in part) on the client device 708. Additionally, the inter-network facilitation system 702 or the dynamic digital tip system 100 can include or communicate with a database for storing information, such as recent direct deposits, ATM withdrawals, debit, or credit transactions, pending transactions, digital account updates, interaction history, and/or other information described herein.

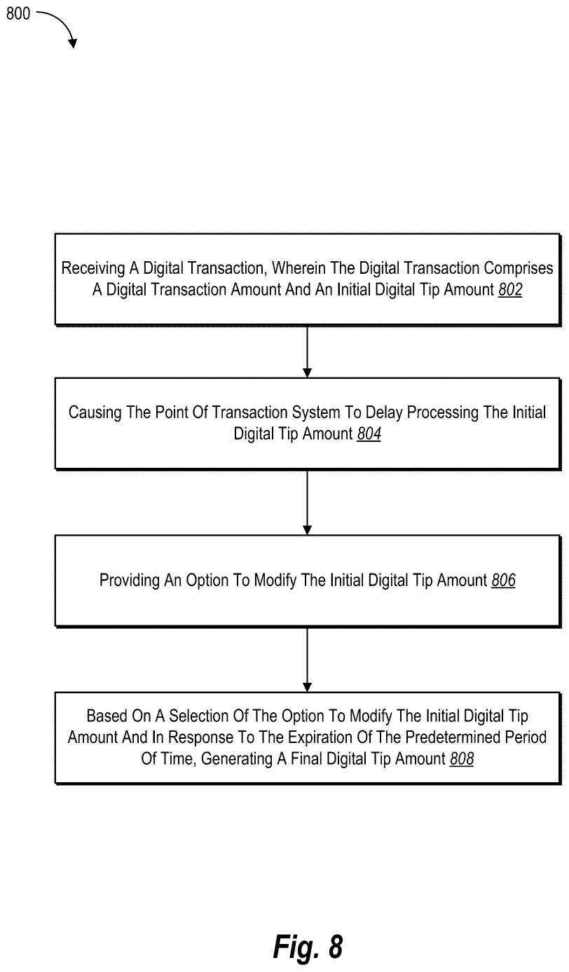

FIGS. 1-7, the corresponding text, and the examples provide a number of different systems, methods, and non-transitory computer readable media for selecting and providing a transportation request to a limited-eligibility provider device. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for causing a point of transaction system to delay processing an initial digital tip amount and further generating a final digital tip. The series of acts 800 can include an act 802 of receiving a digital transaction, wherein the digital transaction comprises a digital transaction amount and an initial digital tip amount. Further, the series of acts 800 can include an act 804 of causing the point of transaction system to delay processing the initial digital tip amount. Moreover, the series of acts 800 can include an act 806 of providing an option to modify the initial digital tip amount. Additionally, the series of acts 800 can include an act 808 of based on a selection of the option to modify the initial digital tip amount and in response to the expiration of the predetermined period of time, generating a final digital tip amount.

In particular the act 802 further includes receiving, from a point of transaction system, a digital transaction corresponding to a user account associated with a client device, wherein the digital transaction comprises a digital transaction amount and an initial digital tip amount. Moreover, the act 804 further includes causing the point of transaction system to delay processing the initial digital tip amount for a predetermined period of time. Further, the act 806 further includes providing, for display on a graphical user interface of the client device and prior to an expiration of the predetermined period of time, an option to modify the initial digital tip amount. Additionally, the act 808 further includes based on a selection of the option to modify the initial digital tip amount and in response to the expiration of the predetermined period of time, generating a final digital tip amount for the point of transaction system to process.

In one or more embodiments, the series of acts 800 includes an act of sending an authorization request to an issuer account system, wherein the authorization request comprises the digital transaction amount and the initial digital tip amount. Furthermore, in one or more embodiments, the series of acts 800 includes an act of receiving authorization for the digital transaction amount from the issuer account system. Moreover, in one or more embodiments, the series of acts 800 includes an act of receiving a unique identifier for the digital transaction, contextual merchant metadata, and contextual tip metadata for the user account associated with the client device.

In one or more embodiments, the series of acts 800 includes an act of receiving the contextual merchant metadata comprises at least one of third-party data sources regarding digital tipping associated with the point of transaction system, or internal data sources corresponding to the point of transaction system regarding digital tipping for the point of transaction system. Furthermore, in one or more embodiments, the series of acts 800 includes an act of receiving the contextual tip metadata for the user account comprises at least one of global user account preferences for digital tipping, local user account preferences for digital tipping, or machine learning model digital tip predictions.

Moreover, in one or more embodiments, the series of acts 800 includes an act of establishing a dynamic communication channel between an issuer account system and the point of transaction system for the predetermined period of time. Further, in one or more embodiments, the series of acts 800 includes an act of sending one or more modifications of the initial digital tip amount to the point of transaction system using the dynamic communication channel within the predetermined period of time.

Moreover, in one or more embodiments, the series of acts 800 includes an act of providing, for display on the graphical user interface of the client device, at least one suggested tip amount based on contextual merchant metadata and contextual tip metadata for the user account. Further, in one or more embodiments, the series of acts 800 includes an act of sending the final digital tip amount to the point of transaction system. In one or more embodiments, the series of acts 800 includes an act of utilizing the point of transaction system to process the final digital tip amount as part of settling the digital transaction.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the client device 708, or the server(s) 706) that may be configured to perform one or more of the processes described above. As shown by FIG. 9, the computing device can comprise a processor 902, memory 904, a storage device 906, an I/O interface 908 interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 702. The network environment 1000 includes a client device 1006 (e.g., client device 708), an inter-network facilitation system 702, and a third-party system 1008 connected to each other by a network 1004. Although FIG. 10 illustrates a particular arrangement of the client device 1006, the inter-network facilitation system 702, the third-party system 1008, and the network 1004, this disclosure contemplates any suitable arrangement of client device 1006, the inter-network facilitation system 702, the third-party system 1008, and the network 1004. As an example, and not by way of limitation, two or more of client device 1006, the inter-network facilitation system 702, and the third-party system 1008 communicate directly, bypassing network 1004. As another example, two or more of client device 1006, the inter-network facilitation system 702, and the third-party system 1008 may be physically or logically co-located with each other in whole or in part.

Moreover, although FIG. 10 illustrates a particular number of client devices 1006, inter-network facilitation systems 702, third-party systems 1008, and networks 1004, this disclosure contemplates any suitable number of client devices 1006, inter-network facilitation system 702, third-party systems 1008, and networks 1004. As an example, and not by way of limitation, network environment 1000 may include multiple client device 1006, inter-network facilitation system 702, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006 and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 10. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 702 may be a network-addressable computing system that can interface between two or more computing networks or servers associated with different entities such as financial institutions (e.g., banks, credit processing systems, ATM systems, or others). In particular, the inter-network facilitation system 702 can send and receive network communications (e.g., via the network 1004) to link the third-party-system 1008. For example, the inter-network facilitation system 702 may receive authentication credentials from a user to link a third-party system 1008 such as an online bank account, credit account, debit account, or other financial account to a user account within the inter-network facilitation system 702. The inter-network facilitation system 702 can subsequently communicate with the third-party system 1008 to detect or identify balances, transactions, withdrawal, transfers, deposits, credits, debits, or other transaction types associated with the third-party system 1008. The inter-network facilitation system 702 can further provide the aforementioned or other financial information associated with the third-party system 1008 for display via the client device 1006. In some cases, the inter-network facilitation system 702 links more than one third-party system 1008, receiving account information for accounts associated with each respective third-party system 1008 and performing operations or transactions between the different systems via authorized network connections.

In particular embodiments, the inter-network facilitation system 702 may interface between an online banking system and a credit processing system via the network 1004. For example, the inter-network facilitation system 702 can provide access to a bank account of a third-party system 1008 and linked to a user account within the inter-network facilitation system 702. Indeed, the inter-network facilitation system 702 can facilitate access to, and transactions to and from, the bank account of the third-party system 1008 via a client application of the inter-network facilitation system 702 on the client device 1006. The inter-network facilitation system 702 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 702 includes a model for approving or denying transactions. For example, the inter-network facilitation system 702 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data packets (from the inter-network facilitation system 702 and/or one or more third-party systems), the inter-network facilitation system 702 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 702 may be accessed by the other components of network environment 1000 either directly or via network 1004. In particular embodiments, the inter-network facilitation system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 702 to manage, retrieve, modify, add, or delete, the information stored in data store.

In particular embodiments, the inter-network facilitation system 702 may provide users with the ability to take actions on various types of items or objects, supported by the inter-network facilitation system 702. As an example, and not by way of limitation, the items and objects may include financial institution networks for banking, credit processing, or other transactions, to which users of the inter-network facilitation system 702 may belong, computer-based applications that a user may use, transactions, interactions that a user may perform, or other suitable items or objects. A user may interact with anything that is capable of being represented in the inter-network facilitation system 702 or by an external system of a third-party system, which is separate from inter-network facilitation system 702 and coupled to the inter-network facilitation system 702 via a network 1004.

In particular embodiments, the inter-network facilitation system 702 may be capable of linking a variety of entities. As an example, and not by way of limitation, the inter-network facilitation system 702 may enable users to interact with each other or other entities, or to allow users to interact with these entities through an application programming interfaces (“API”) or other communication channels.

In particular embodiments, the inter-network facilitation system 702 may include a variety of servers, sub-systems, programs, modules, logs, and data stores. In particular embodiments, the inter-network facilitation system 702 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 702 may also include suitable components such as network interfaces, security mechanisms, load balancers, failover servers, management-and-network-operations consoles, other suitable components, or any suitable combination thereof. In particular embodiments, the inter-network facilitation system 702 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 702 and one or more client devices 1006. An action logger may be used to receive communications from a web server about a user's actions on or off the inter-network facilitation system 702. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 702. A privacy setting of a user determines how particular information associated with a user can be shared. The authorization server may allow users to opt in to or opt out of having their actions logged by the inter-network facilitation system 702 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 702 via the network 1004. A third-party system 1008 can communicate with the inter-network facilitation system 702 to provide financial information pertaining to balances, transactions, and other information, whereupon the inter-network facilitation system 702 can provide corresponding information for display via the client device 1006. In particular embodiments, a third-party system 1008 communicates with the inter-network facilitation system 702 to update account balances, transaction histories, credit usage, and other internal information of the inter-network facilitation system 702 and/or the third-party system 1008 based on user interaction with the inter-network facilitation system 702 (e.g., via the client device 1006). Indeed, the inter-network facilitation system 702 can synchronize information across one or more third-party systems to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, from a point of transaction system, a digital transaction corresponding to a user account associated with a client device, wherein the digital transaction comprises a digital transaction amount and an initial digital tip amount;
causing the point of transaction system to delay processing the initial digital tip amount for a predetermined period of time;
providing, for display on a graphical user interface of the client device and prior to an expiration of the predetermined period of time, an option to modify the initial digital tip amount; and
based on a selection of the option to modify the initial digital tip amount and in response to the expiration of the predetermined period of time, generating a final digital tip amount for the point of transaction system to process.

2. The computer-implemented method of claim 1, wherein receiving the digital transaction further comprises:
sending an authorization request to an issuer account system, wherein the authorization request comprises the digital transaction amount and the initial digital tip amount; and
receiving authorization for the digital transaction amount from the issuer account system.

3. The computer-implemented method of claim 1, wherein receiving the digital transaction further comprises receiving a unique identifier for the digital transaction, contextual merchant metadata, and contextual tip metadata for the user account associated with the client device.

4. The computer-implemented method of claim 3, wherein:
receiving the contextual merchant metadata comprises at least one of third-party data sources regarding digital tipping associated with the point of transaction system, or internal data sources corresponding to the point of transaction system regarding digital tipping for the point of transaction system; and
receiving the contextual tip metadata for the user account comprises at least one of global user account preferences for digital tipping, local user account preferences for digital tipping, or machine learning model digital tip predictions.

5. The computer-implemented method of claim 1, wherein causing the point of transaction system to delay processing the initial digital tip amount comprises:
establishing a dynamic communication channel between an issuer account system and the point of transaction system for the predetermined period of time; and
sending one or more modifications of the initial digital tip amount to the point of transaction system using the dynamic communication channel within the predetermined period of time.

6. The computer-implemented method of claim 1, wherein providing the option to modify the initial digital tip amount comprises providing, for display on the graphical user interface of the client device, at least one suggested tip amount based on contextual merchant metadata and contextual tip metadata for the user account.

7. The computer-implemented method of claim 1, wherein generating the final digital tip amount comprises:
sending the final digital tip amount to the point of transaction system; and
utilizing the point of transaction system to process the final digital tip amount as part of settling the digital transaction.

8. A non-transitory computer-readable medium storing instructions that, when executed by at least one processor, cause a computer system to:
receive, from a point of transaction system, a digital transaction corresponding to a user account associated with a client device, wherein the digital transaction comprises a digital transaction amount and an initial digital tip amount;
cause the point of transaction system to delay processing the initial digital tip amount for a predetermined period of time;
provide, for display on a graphical user interface of the client device and prior to an expiration of the predetermined period of time, an option to modify the initial digital tip amount; and
based on a selection of the option to modify the initial digital tip amount and in response to the expiration of the predetermined period of time, generate a final digital tip amount for the point of transaction system to process.

9. The non-transitory computer-readable medium of claim 8, that, when executed by the at least one processor, cause the computer system to receive the digital transaction by:
sending an authorization request to an issuer account system, wherein the authorization request comprises the digital transaction amount and the initial digital tip amount; and
receiving authorization for the digital transaction amount from the issuer account system.

10. The non-transitory computer-readable medium of claim 8, that, when executed by the at least one processor, cause the computer system to receive the digital transaction comprising a unique identifier for the digital transaction, contextual merchant metadata, and contextual tip metadata for the user account associated with the client device.

11. The non-transitory computer-readable medium of claim 10, that, when executed by the at least one processor, cause the computer system to:
receive the contextual merchant metadata comprising at least one of third-party data sources regarding digital tipping associated with the point of transaction system, or internal data sources corresponding to the point of transaction system regarding digital tipping for the point of transaction system; and
receive the contextual tip metadata for the user account comprising at least one of global user account preferences for digital tipping, local user account preferences for digital tipping, or machine learning model digital tip predictions.

12. The non-transitory computer-readable medium of claim 8, that, when executed by the at least one processor, cause the computer system to cause the point of transaction system to delay processing the initial digital tip amount by:
establishing a dynamic communication channel between an issuer account system and the point of transaction system for the predetermined period of time; and
sending one or more modifications of the initial digital tip amount to the point of transaction system using the dynamic communication channel within the predetermined period of time.

13. The non-transitory computer-readable medium of claim 8, that, when executed by the at least one processor, cause the computer system to provide the option to modify the initial digital tip amount by providing, for display on the graphical user interface of the client device, at least one suggested tip amount based on contextual merchant metadata and contextual tip metadata for the user account.

14. The non-transitory computer-readable medium of claim 8, that, when executed by the at least one processor, cause the computer system to generate the final digital tip amount by:
sending the final digital tip amount to the point of transaction system; and
utilizing the point of transaction system to process the final digital tip amount as part of settling the digital transaction.

15. A system comprising:
at least one processor; and
at least one non-transitory computer-readable storage medium storing instructions that, when executed by the at least one processor, cause the system to:
receive, from a point of transaction system, a digital transaction corresponding to a user account associated with a client device, wherein the digital transaction comprises a digital transaction amount and an initial digital tip amount;
cause the point of transaction system to delay processing the initial digital tip amount for a predetermined period of time;
provide, for display on a graphical user interface of the client device and prior to an expiration of the predetermined period of time, an option to modify the initial digital tip amount; and
based on a selection of the option to modify the initial digital tip amount and in response to the expiration of the predetermined period of time, generate a final digital tip amount for the point of transaction system to process.

16. The system of claim 15, that when executed by the at least one processor, cause the system to receive the digital transaction by:
sending an authorization request to an issuer account system, wherein the authorization request comprises the digital transaction amount and the initial digital tip amount; and
receiving authorization for the digital transaction amount from the issuer account system.

17. The system of claim 15, that when executed by the at least one processor, cause the system to receive the digital transaction comprising a unique identifier for the digital transaction, contextual merchant metadata, and contextual tip metadata for the user account associated with the client device.

18. The system of claim 17, that when executed by the at least one processor, cause the system to:
receive the contextual merchant metadata comprising at least one of third-party data sources regarding digital tipping associated with the point of transaction system, or internal data sources corresponding to the point of transaction system regarding digital tipping for the point of transaction system; and
receive the contextual tip metadata for the user account comprising at least one of global user account preferences for digital tipping, local user account preferences for digital tipping, or machine learning model digital tip predictions.

19. The system of claim 15, that when executed by the at least one processor, cause the system to cause the point of transaction system to delay processing the initial digital tip amount by:
establishing a dynamic communication channel between an issuer account system and the point of transaction system for the predetermined period of time; and
sending one or more modifications of the initial digital tip amount to the point of transaction system using the dynamic communication channel within the predetermined period of time.

20. The system of claim 15, that when executed by the at least one processor, cause the system to provide the option to modify the initial digital tip amount by providing, for display on the graphical user interface of the client device, at least one suggested tip amount based on contextual merchant metadata and contextual tip metadata for the user account.
